(19) United States
(12) Patent Application Publication
(10) Pub. No.: US 2003/0224963 A1
(43) Pub. Date: Dec. 4, 2003

(54) Alkyl phenyl alkanols, derivatives thereof and detergent compositions comprising same

(75) Inventors: Jeffrey John Scheibel, Loveland, OH (US); Daniel Stedman Connor, Cincinnati, OH (US)

Correspondence Address: THE PROCTER & GAMBLE COMPANY, INTELLECTUAL PROPERTY DIVISION, WINTON HILL TECHNICAL CENTER - BOX 161, 6110 CENTER HILL AVENUE, CINCINNATI, OH, 45224, US

(73) Assignee: The Procter & Gamble Company

(21) Appl. No.: 10/442,813

(22) Filed: May 21, 2003

Related U.S. Application Data
(60) Provisional application No. 60/383,220, filed on May 24, 2002.

(51) Int. Cl. C11D 1/00

(52) U.S. Cl. 510/492

(57) ABSTRACT

Alkyl phenyl alkanols, alkyl phenyl alkanol derivatives and detergent compositions comprising same. More specifically, alkyl phenyl alkanols and alkyl phenyl alkanol derivatives that provide enhanced primary biodegradability elative to conventional surfactants such as alkyl phenol ethoxylates.

### CROSS REFERENCE

This application claims priority to Provisional Application Serial No. 60/383,220, filed May 24, 2002.

### FIELD OF THE INVENTION

The present invention relates to alkyl phenyl alkanols, alkyl phenyl alkanol derivatives and detergent compositions comprising the same. More specifically, the present invention relates to alkyl phenyl alkanols that provide enhanced biodegradability relative to conventional alkyl phenol derived surfactants. The detergent compositions employing the alkyl phenyl alkanol derivatives of the present invention provide enhanced cleaning performance relative to conventional alkyl phenols, while conveying the benefits of increased biodegradation relative to conventional alkyl phenol derived surfactants.

### BACKGROUND OF THE INVENTION

Alkyl phenol ethoxylates (hereinafter “APEs”) are generally known in the art and are employed in a variety of applications. APEs have achieved wide acceptance due largely in part to their versatility and low cost. Artisans are able to tailor APEs for specific applications by selecting the alkyl substituent on the phenol group and controlling the number of repeating ethoxy components attached to the oxygen atom that is bonded to the phenol group. Such customization allows artisans to employ APEs in the broad domestic arena of cosmetics, detergents and toiletries and the industrial venues of oil slick dispersants, deinking surfactants, metal treatment, textile treatment, emulsion formation, emulsion polymerization, detergents and cleaners and the like.

Nevertheless, the modem employment of APEs in the above-mentioned contexts has been at least partially limited by environmental concerns. In particular, some of those skilled in the art have attributed the employment of conventional APEs, and in particular their precursor alkyl phenols (hereinafter “APs”), with deficient primary biodegradation. Indeed, a few studies have suggested that conventional APEs experience delayed or deficient primary biodegradation, thus generating intermediate biodegradation products, such as APs, lower ethoxylate APEs (e.g. APE₁ and APE₂) and carboxylate byproducts

The highly branched alkyl chains of alkyl phenol ethoxylates encourage the formation of intermediates during decomposition. Consequently, alkyl phenol ethoxylates with a high degree of branching produce an increased concentration of intermediates during biodegradation, and thus, have environmental concerns.

The aforementioned concerns have prompted the implementation of governmental restrictions of APEs in Europe and voluntary, industrial restrictions of the compounds in the United States. Those skilled in the art have since been relatively unsuccessful in identifying any meaningful alternatives to conventional APEs. Thus, there remains a significant need to identify, develop and employ alternatives to conventional APEs and their precursors that possess the characteristics of increased biodegradation. Until such APE alternatives are discovered, future employment of the surfactants may likely entail adverse affects to the environment.

It has surprisingly been discovered that certain, precise modifications of conventional APs, and thus modifications in the resultant APEs, can produce modified compounds characterized by increased biodegradation. Indeed, the present invention relates to alkyl phenyl alkanols and alkyl phenyl alkanol derivatives, which exhibit increased biodegradability as compared with conventional APs and APEs. The present invention addresses and resolves the inadequacies of conventional APEs and facilitates the continued employment of similarly acting compounds, while minimizing adverse affects on the environment.

### SUMMARY OF THE INVENTION

The present invention relates to a compound having the formula:

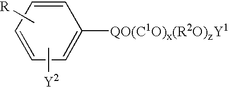

wherein R is C₅-C₃₀ linear or branched alkyl, and mixtures thereof; R¹ and R² are independently selected from linear or branched C₁-C₆ alkylene; Q is a hydrocarbon moiety containing between one and six carbon atoms; Y¹ and Y² are hydrogen, SO₃M, and mixtures thereof; the index x is from 0 to 50; the index z is from 0 to 20; and M is an alkali metal, alkaline earth metal, organic counterion, ammonium, substituted ammonium or mixtures thereof.

The present invention also relates to a surfactant system comprising compounds represented by formula (I) above and one or more surfactants selected from the group consisting of: alkylbenzensulfonates; linear alkylbenzenesulfonates; modified linear alkylbenzenesulfonates; linear, branched and mid-chain branched alkanolsulfates; linear, branched and mid-chain branched alkanolethoxylates; linear, branched and mid-chain branched alkanolethoxyatesulfates; alkylpolyglucanols; alphaolefinsulfonates, methylestersulfonates; and mixtures thereof.

The present invention further relates to a detergent composition comprising the compounds represented by formula (I) above.

The above-mentioned embodiments and other aspects of the present invention are more fully described and exemplified in the Detailed Description, as follows. All percentages, ratios and proportions herein are by weight of a detergent composition unless otherwise specified. All temperatures are in degrees Celsius (° C.) unless otherwise specified. All references included herein are incorporated by reference.

### DETAILED DESCRIPTION OF THE INVENTION

The novel features of the present compounds facilitate the continued and non-hazardous employment of alkyl phenyl alkanols and alkyl phenyl alkanol derivatives by those skilled in the art. Specifically, the present invention relates to alkyl phenyl alkanols and alkyl phenyl alkanol derivatives characterized by alkyl chains with specific physical size, degree and type of branching. The present invention further promotes primary biodegradation of the claimed compounds by increasing the linearity and by controlling the position of attachment of the aromatic moiety to the alkyl chain. Moreover, the present invention discusses the placement of an alkyl spacer or separation unit between the aromatic moiety and the hydroxyl group, in contrast with the direct attachment of the hydroxyl group to the aromatic moiety as with conventional alkyl phenols and derivatives thereof.

As used here “biodegradation” refers to the bacterial decomposition of a chemical. For surfactants, including alkyl phenol ethoxylates, it generally involves “primary biodegradation” meaning the loss of surfactant properties and “ultimate biodegradation” meaning complete degradation of the compound to carbon dioxide and water.

It is important to note that the precise mechanism of biodegradation of a surfactant is still not known. However, the specific biodegradation of such compounds generally involves the following steps. Initially, methyl group oxidation converts a terminal methyl group (CH₃) to a carboxyl group (COOH). Beta group oxidation of a terminal carboxylate group then takes place. Thus, methyl group oxidation constitutes a precursor to beta group oxidation. Aromatic ring oxidation entails an oxidative cleavage of the ring structure. This cleavage is followed by rearrangement and hydration to yield an aliphatic dicarboxylic acid. The beta-oxidation process may further degrade this structure.

The measurement of biodegradation of APEs is not based on the ultimate biodegradation. Rather, those skilled in the art measure the time it takes for the compound to begin to lose surfactant properties or the primary biodegradation. Alkyl phenol ethoxylates, in particular, only degrade from opposite ends and thus do not lose surfactant properties until the molecule experiences substantial biodegradation. As a result, conventional APEs experience delayed or deficient primary biodegradation.

The present invention maximizes the biodegradation characteristics of the claimed compounds by controlling several factors, including the physical size, degree and type of branching of the alkyl chain of the claimed compounds. Moreover, the present invention may be further capable of maximizing the rate of biodegradation of the claimed compounds by controlling the position of attachment of the phenyl alkanol or other aromatics to the alkyl chain of said compounds. Formula (I) illustrates said compounds:

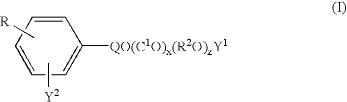

wherein R of formula (I) is C₅-C₃₀, preferably C₆-C₁₃, linear or lightly branched alkyl, and mixtures thereof; R¹ and R² of formula (I) are independently selected from C₂-C₆ linear or branched, and mixtures thereof; Q of formula (I) is a hydrocarbon moiety containing between one and six carbon atoms, Y¹ and Y² of formula (I) are independently selected from hydrogen; SO₃M (sulfate and/or sulfonate), and mixtures thereof; x of formula (I) is from 0 to 50 and z is from 0 to 20; M of formula (1) is an alkali metal, alkaline earth metal, organic counterion, ammonium, substituted ammonium and mixtures thereof.

One preferred embodiment comprises nonionic varieties, wherein R¹ and R² are preferably C₂ and C₃, or ethoxylated and propoxylated species. Such compounds may comprise a single species, where x=0 or z=0, random mixtures, or blocks of ethoxy and propoxy species. In such nonionic varieties, Y¹ and Y² of formula (I) are hydrogen, the index x is preferably from 0 to 20 and the index z is preferably from 0 to 3. In one embodiment of the present invention Q is a hydrocarbon moiety comprising 1 carbon atom, which can be —CH₂—. In another embodiment of the nonionic varieties, Q is a hydrocarbon moiety comprising two or more carbon atoms that can be represented by the structure —CH₂CH₂—. In yet another embodiment of the present invention, Q can be substantially free from quaternary type carbon atoms. Mixtures of the nonionic varieties are also considered by the present invention.

In another preferred embodiment of the present invention formula (I) is such that anionic varieties, and specifically the sulfate and sulfonate species, are disclosed. Such anionic varieties are such that R¹ and R² are independently selected from linear or branched C₂ to C₆, and mixtures thereof; Y¹ is hydrogen, SO₃M and mixtures thereof; Y² is hydrogen, SO₃M and mixtures thereof, provided that at least one of Y¹ or Y² is SO₃M, the index x is preferably from 0 to 20; the index z is preferably from 0 to 3; M is selected from the group comprising: sodium, potassium, magnesium, calcium, monoethanolamine (MEA), triethanolamine (TEA) and mixtures thereof. These compounds may be employed individually or in combination, depending on the application for which employment is sought. Moreover, the partially sulfated and/or sulfonated derivatives, e.g. mixtures of the above-listed compounds, are considered by the present invention.

Branching of Alkyl Chain—One purpose of the present invention is to provide an alkyl phenyl alkanol characterized by an appropriate degree of substitution of the alkyl chain, such that primary biodegradation is promoted. With regards to the physical characteristics of formula (I), the present invention teaches minimizes the degree of substitution or branching, and thus, minimizing the bulk of the subject alkyl phenyl alkanol. The minimization of the bulk of the alkyl group, depicted as the R moiety in formula (I), of the alkyl phenyl alkanol, as well as the alkyl phenyl alkanol derivatives, of the present invention has the benefit of increasing the effective hydrophobicity of the compound's alkyl chain for a given weight average molecular weight. The increased effective hydrophobicity of the present invention, in turn, promotes heightened surface activity of the subject alkyl phenyl alkanols and alkyl phenyl alkanol derivatives. Said activity has the affect of increasing the cleaning performance of the present alkyl phenyl alkanols and alkyl phenyl alkanol derivatives, while promoting swift primary decomposition of the same. Thus, the compounds disclosed herein provide meaningful enhancements upon the primary biodegradation characteristics of conventional alkyl phenols. Such enhancement, of course, results in the increased decomposition of the present alkyl phenyl alkanols and alkyl phenyl alkanol derivatives.

Randomized And Nonrandomized Branching—Another aspect of the present invention is to minimize the degree of substitution to which the subject alkyl phenyl alkanols, and specifically their alkyl chains represented by the R moiety of formula (I), are branched. Lightly branched or linear alkyl chains characterize the alkyl phenyl alkanols and alkyl phenyl alkanol derivatives of the present invention. The alkyl chains of the present compounds may comprise between zero to two branches. In one embodiment, the alkyl chains of the present compounds comprise zero branches, and thus, are linear. In another embodiment, the alkyl chains of the present compounds comprise branching of the alkyl chain, which are preferably methyl or ethyl, and are considered lightly branched. The methyl or ethyl branching may be randomized or nonrandomized. “Randomized” as used herein refers to the specific branch positions of the alkyl chain being random or at various places on the alkyl chain. “Nonrandomized” as used herein refers to branched positions on specific positions on the alkyl chain. Moreover, mixtures of lightly branched and linear alkyl chains constitute yet another embodiment of the alkyl phenyl alkanols of the present invention. Although not preferred, branching greater than that of ethyl may be present.

A third aspect of the present invention is to control the quaternary branching of the alkyl chains, represented by the R moiety of formula (I) of the present alkyl phenyl alkanols, and derivatives thereof. Said quaternary branching refers to dialkyl substitution at the same position on the alkyl chain and may also entail alkyl substitution and aromatic moiety attachment at the same position on the alkyl chain. Quaternary branching has the general affect of inhibiting the primary biodegradation of conventional alkyl phenols. In fact, the deficient primary biodegradation of many conventional alkyl phenols may be attributed to the prevalence of quaternary branching on the alkyl chains of said compounds. It is preferred that the alkyl phenyl alkanols and derivatives thereof of the present invention disclosed herein are substantially free from quaternary type branching. By “substantially free” as used herein throughout the description, it is meant that the compounds of the present embodiment comprise no greater than 5 mole percent, preferably no greater than 1 mole percent, more preferably no greater than 0.1 mole percent of quaternary branching of the alkyl chains, represented by the R moiety of formula (I) of the present alkyl phenyl alkanols, and derivatives thereof.

Attachment Position of Phenol to Alkyl Chain—It has also been discovered that the position of attachment of the aromatic ring on the alkyl chain, represented by the R moiety of formula (I), affects primary biodegradation. Indeed, it is a fundamental aspect of the present invention to control the position of attachment of the aromatic ring on the alkyl chain to promote the primary biodegradation of the alkyl phenyl alkanols and alkyl phenyl alkanol derivatives of the present invention. Specifically, the present invention is characterized by terminal or near terminal attachment of the phenyl alkanol onto the alkyl chain, as illustrated in structure (II).

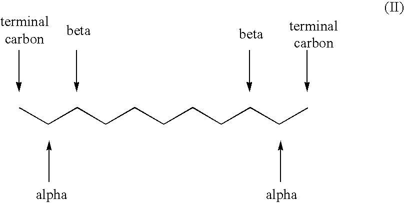

“Near terminal” as used herein is defined as the alpha or beta attachment of the aromatic ring relative to the terminal carbon of the alkyl chain, represented by the R moiety in formula (I). To better explain this, the above-depicted structure (II) illustrates the two possible alpha positions and the two possible beta position in a general linear alkyl chain. The controlled positioning of aromatic ring attachment onto the alkyl chain of the alkyl phenyl alkanol and alkyl phenyl alkanol derivatives of the present invention has the additional benefit of increasing the detergency performance of the derivatives of said compounds.

Attachment of Phenol To Hydroxyl Group—Moreover, the alkyl phenyl alkanols of the present invention, as well as derivatives thereof, further promote primary biodegradation via controlled positioning of the subject hydroxyl group. Such “hydoxyl groups” are represented by the —O(R¹O)ₓ(R²O)Y¹ moiety in formula (I), wherein Y¹ is hydrogen. Indeed, the present invention seeks to prevent direct attachment of the hydroxyl group to the aromatic ring of the subject alkyl phenyl alkanols and alkyl phenyl alkanol derivatives. The present invention teaches away from direct attachment of the hydroxyl group to the aromatic ring via the strategic and specific placement of a spacer or separation unit between the aromatic ring and hydroxyl group of the subject alkyl phenyl alkanols and alkyl phenyl alkanol derivatives.

As used herein a “spacer” or “separation unit” is defined to be a moiety other than a hydroxyl group that connects the hydroxyl group to the aromatic ring of the subject alkyl phenyl alkanols and alkyl phenyl alkanol derivatives and is represented by the Q moiety in formula (I). The present invention further seeks to encourage primary biodegradability of the present alkyl phenyl alkanols and their derivatives via placement of a spacer or separation group between the subject hydroxyl group and the aromatic ring. Initially, it must be underscored that the alkyl phenyl alkanols of the present invention are not phenols. That is to say, the indirect attachment of the subject hydroxyl group to the aromatic ring of the present compounds eliminates the donation of electrons from the electron-enriched oxygen group to the aromatic ring. Without wishing to be bound by theory, it is believed that the indirect attachment of the hydroxyl group to the aromatic ring results in the decreased polarization and polarizability of the present alkyl phenyl alkanols, thereby increasing their primary biodegradability. However, it should be noted, that such indirect attachment preserves surfactancy properties of the present compounds that are comparable to conventional APEs. Moreover, the present compounds are characterized by detergency properties similar to those of conventional APEs.

Moreover, the present invention seeks to control additional factors that are believed to contribute to enhanced detergency characteristics of the subject alkyl phenyl alkanols disclosed herein. The compounds of the present embodiment may be characterized by para-positioning of the R and Q moieties, relative to each other on the aromatic ring. Nevertheless, positioning of the R and Q moieties, relative to each other on the aromatic ring, may also occur in the ortho- and meta-configurations. Indeed, the compounds of the present invention may further possess R and Q positioning in mixtures of the aforementioned positions.

The sulfate group (e.g. C—O—S) of the present anionic compounds, specifically, further encourages the primary/ultimate biodegradation of the present compounds, as compared with the bio-resistant C—S bond of the aromatic sulfonate group. Generally, the degree to which compounds are ethoxylated is low (i.e. x+z=average of from 1 to 3) in the anionic species of the compounds of the present invention, and therefore, residual surface activity of the nonionic intermediates is low. Thus, it is important to underscore that the compounds of the present embodiment are particularly adapted for enhanced primary/ultimate biodegradation, in comparison to conventional APEs. The alkyl phenyl alkanols and derivatives thereof are exemplified in the following examples

### PREPARATIVE EXAMPLES

### Example 1

### Synthesis of C₁₀-C₁₃ Methyl-Substituted Alkyl Phenyl Alkanol (Q=CH₂—)

Step A: Preparation of C₁₀-C₁₃ Methyl-Substituted Alkyl Benzene

1. A mixture of 4.65 g of 2-pentanone, 20.7 g of 2-hexanone, 51.0 g of 2-heptanone, 36.7 g of 2-octanone and 72.6 g of diethyl ether is added to an addition funnel. The ketone mixture is then added dropwise over a period of 2.25 hours to a nitrogen blanketed stirred three neck 2 L round bottom flask, fitted with a reflux condenser and containing 600 mL of 2.0 M n-pentylmagnesium bromide in diethyl ether and an additional 400 mL of diethyl ether. After the addition is complete the reaction mixture is stirred an additional 2.5 hours at 20° C. The reaction mixture is then added to 1 kg of cracked ice with stirring. To this mixture is added 393.3 g of 30% sulphuric acid solution. The aqueous acid layer is drained and the remaining ether layer is washed twice with 750 mL of water. The ether layer is then evaporated under vacuum to yield 176.1 g of a mixture of 4-methyl-4-nonanol, 5-methyl-5-decanol, 6-methyl-6-undecanol and 6-methyl-6-dodecanol.

2. A 174.9 g sample of the mono methyl branched alcohol mixture of Step A1 is added to a nitrogen blanketed stirred three neck round bottom 500 mL flask, fitted with a Dean Stark trap and a reflux condenser along with 35.8 g of a shape selective zeolite catalyst such as anacidic mordenite catalyst ZEOCAT® FM-8/25H. With mixing, the mixture is then heated to about 110-155° C. and water and some olefin is collected over a period of 4-5 hours in the Dean Stark trap. The conversion of the alcohol mixture of Step A1 to a substantially non-randomized methyl branched olefin mixture is now complete. The substantially non-randomized methyl branched olefin mixture remaining in the flask along with the substantially non-randomized methyl branched olefin mixture collected in the Dean Stark trap is recombined and filtered to remove catalyst. The solid filter cake is washed twice with 100 mL portions of hexane. The hexane filtrate is evaporated under vacuum and the resulting product is combined with the first filtrate to give 148.2 g of a substantially non-randomized methyl branched olefin mixture.

3. The olefin mixture of Step A2 is combined with 36 g of a shape selective zeolite catalyst (acidic mordenite catalyst ZEOCAT® FM-8/25H) and reacted according to Step A2 with the following changes. The reaction temperature is raised to 190-200° C. for a period of about 1-2 hours to randomize the specific branch positions in the olefin mixture. The substantially mono methyl branched olefin mixture with randomized branching remaining in the flask along with the substantially mono methyl branched olefin mixture with randomized branching collected in the Dean Stark trap are recombined and filtered to remove catalyst. The solid filter cake is washed twice with 100 mL portions of hexane. The hexane filtrate is evaporated under vacuum and the resulting product is combined with the first filtrate to give 147.5 g of a substantially mono methyl branched olefin mixture with randomized branching.

4. 147 g of the substantially mono methyl branched olefin mixture of Step A3 and 36 g of a shape selective zeolite catalyst (acidic mordenite catalyst ZEOCAT® FM-8/25H) are added to a 2-gallon stainless steel, stirred autoclave. Residual olefin and catalyst in the container are washed into the autoclave with 300 mL of n-hexane and the autoclave is sealed. From outside the autoclave cell, 2000 g of benzene (contained in a isolated vessel and added by way of an isolated pumping system inside the isolated autoclave cell) is added to the autoclave. The autoclave is purged twice with 1.7 MPa (250 psig) N₂, and then charged to 0.4 MPa (60 psig) N₂. The mixture is stirred and heated to about 200° C. for about 4-5 hours. The autoclave is cooled to about 20° C. overnight. The valve is opened leading from the autoclave to the benzene condenser and collection tank. The autoclave is heated to about 120° C. with continuous collection of benzene. No more benzene is collected by the time the reactor reaches 120° C. The reactor is then cooled to 40° C. and 750 g of n-hexane is pumped into the autoclave with mixing. The autoclave is then drained to remove the reaction mixture. The reaction mixture is filtered to remove catalyst and the n-hexane is removed under vacuum. The product is distilled under vacuum (133-667 Pa; 1-5 mm of Hg). The substantially mono methyl branched alkylbenzene mixture with benzene substitution at the alpha- or beta-carbon of the alkyl chain is collected from 76° C.-130° C. (167 g).

Step B: Synthesis of C₁₀-C₁₃ Alkyl Phenyl Alkanol via Formaldehyde Addition

1. Product of Step A4 is reacted with formaldehyde under Friedel Kraffts reaction conditions to form, principally, mixtures of the below-depicted formula (III):

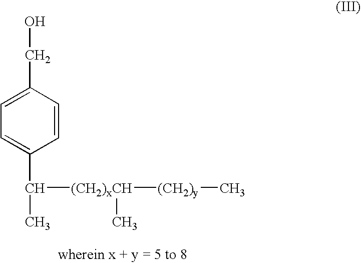

Note, attachment of the alkanol group of formula (III) assumes para positioning, yet one skilled in the art will recognize that positioning in the meta- and/or ortho-configurations may also be present.

### Example 2

### Synthesis of C₁₀-C₁₃ Methyl-Substituted Alkyl Phenyl Alkanol (Q=—CH₂CH₂—)

Step A: Repeat Step A from Example 1

Step B: Product of Step A4 from Example 1 is reacted with ethylene oxide under Friedel Kraffts reaction conditions to form, principally, mixtures of formula (IV):

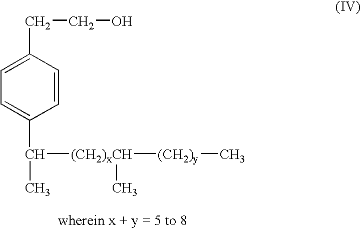

Note, attachment of the alkanol group of formula (IV) assumes para positioning, yet one skilled in the art will recognize positioning in the meta- and/or ortho-configurations may also be present.

### Example 3

### Synthesis of C₁₀-C_Linear Alkyl Phenyl Alkanol (Q=—CH₂—)

Step A: Synthesis of C₁₀-C₁₃ Linear Alkyl Benzene Mixture

A mixture of chain lengths of substantially linear alkylbenzenes with the benzene substitution at the alpha- or beta-carbon of the alkyl chain is prepared using a shape zeolite catalyst (acidic mordenite catalyst ZEOCAT® FM-8/25H). A mixture of 15.1 g of NEODENE®10, 136.6 g of NEODENE® 1112, 89.5 g of NEODENE® 12 and 109.1 g of 1-tridecene is added to a 2 gallon stainless steel, stirred autoclave along with 70 g of a shape selective catalyst (acidic mordenite catalyst ZEOCA® FM-8/25H). Residual olefin and catalyst in the container are washed into the autoclave with 200 mL of n-hexane and the autoclave is sealed. From outside the autoclave cell, 2500 benzene (contained in a isolated vessel and added by way of an isolated pumping system inside the isolated autoclave cell) is added to the autoclave. The autoclave is purged twice with 1.7 MPa (250 psig) N₂, and then charged to 0.4 MPa (60 psig) N₂. The mixture is stirred and heated to about 200-205° C. for about 4-5 hours then cooled to 70-80° C. The valve is opened leading from the autoclave to the benzene condenser and collection tank. The autoclave is heated to about 120° C. with continuous collection of benzene in collection tank. No more benzene is collected by the time the reactor reaches 120° C. The reactor is then cooled to 40° C. and 1 kg of n-hexane is pumped into the autoclave with mixing. The autoclave is then drained to remove the reaction mixture. The reaction mixture is filtered to remove catalyst and the n-hexane is evaporated under low vacuum. The product is then distilled under high vacuum (133 Pa-667 Pa or 1-5 mm of Hg). The substantially linear alkylbenzene mixture with the benzene substitution at the alpha- or beta-carbon of the alkyl chain is collected from 85° C.-150° C. (426.2 g).

Step B: Synthesis of C₁₀-C₁₃ Linear Alkyl Phenyl Alkanol (formula (I) Q=—CH₂— or —CH₂CH₂—)

React the product of Step A with either formaldehyde or ethylene oxide under Freidel Kraffts reaction conditions to form the below-depicted formula (V) and (VI):

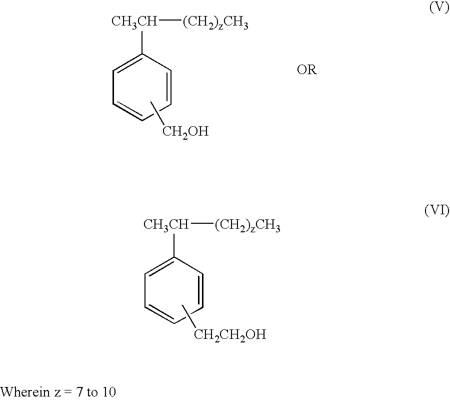

### Example 4

### Synthesis of C₁₀-C₁₃ Methyl Substituted Alkyl Phenyl Alkanol Ethoxylate (Formula (I) Q=—CH₂—)

The alkanol of Example 1 is treated with 1 mole percent sodium metal and then ethylene oxide at 135° C. until 3 mole equivalents are added.

### Example 5

### Synthesis of C₁₀-C₁₃ Linear Alkyl Phenyl Alkanol Ethoxylate (Formula (I) Q=CH₂CH₂—)

The alkanol of Example 3 is treated with 1 mole percent sodium metal and then ethylene oxide at 135° C. until 3 mole equivalents are added.

### Example 6

### Synthesis of Sodium C₁₀-C₁₃ Methyl Substituted Alkyl Phenyl Alkanol Sulfate

The alkanol of Example 1 is treated with two volumes of dry chloroform and add one mole equivalent of chlorosulfonic acid at 25° C. Pull off hydrogen chloride with vacuum and dissolve in 1.05 equivalent amount of sodium methoxide until completely neutralized at 25° C. Evaporate off chloroform and methanol via pan drying.

### Example 7

### Synthesis of Sodium C₁₀-C₁₃ Linear Alkyl Phenyl Alkanol Sulfate

The alkanol of Example 3 is treated with two volumes of dry chloroform and add one mole equivalent of chlorosulfonic acid at 25° C. Pull off hydrogen chloride with vacuum and dissolve in 1.05 equivalent amount of sodium methoxide until completely neutralized at 25° C. Evaporate off chloroform and methanol via pan drying.

### Example 8

### Synthesis of Sodium C₁₀-C₁₃ Methyl Substituted Alkyl Phenyl Alkanol Ethoxylate Sulfate

The ethoxylate of Example 4 is treated with two volumes of dry chloroform and add one mole equivalent of chlorosulfonic acid at 25° C. Pull off hydrogen chloride with vacuum and dissolve in 1.05 equivalent amount of sodium methoxide until completely neutralized at 25° C. Evaporate off chloroform and methanol via pan drying.

### Example 9

### Synthesis of Sodium C₁₀-C₁₃ Linear Alkyl Phenyl Alkanol Ethoxylate Sulfate

The ethoxylate of Example 5 is treated with two volumes of dry chloroform and add one mole equivalent of chlorosulfonic acid at 25° C. Pull off hydrogen chloride with vacuum and dissolve in 1.05 equivalent amount of sodium methoxide until completely neutralized at 25° C. Evaporate off chloroform and methanol via pan drying.

Detergent Compositions

In still another aspect of the present invention, detergent compositions, especially laundry detergent compositions, comprising the compounds of the present invention, and particularly the alkyl phenyl alkanol sulfates, alkyl phenyl alkanol ethoxylates and alkyl phenyl alkanol ethoxysulfates, are provided.

Such detergent compositions generally contain an amount of the present compounds useful in cleaning fabrics. In one embodiment of the present invention, the detergent compositions of the present invention comprise one or more surfactants selected from the group consisting of: alkylbenzensulfonates (ABS); linear alkylbenzenesulfonates (LAS); modified linear alkylbenzenesulfonates (MLAS), see WO 02/092737, linear, branched and mid-chain branched alkanolsulfates (AS); linear, branched and mid-chain branched alkanolethoxylates (AE); linear, branched and mid-chain branched alkanolethoxyatesulfates (AES); alkylpolyglucanols (APG); alphaolefinsulfonates (AOE), methylestersulfonates (MES); and mixtures thereof. The surfactant is typically present at a level of from about 0.1%, preferably about 1%, more preferably about 5% by weight of the detergent compositions to about 99.9%, preferably about 80%, more preferably about 35%, most preferably 30% about by weight of the detergent compositions.

The alkyl phenyl alkanols of the present invention, both anionic and nonionic embodiments, can be incorporated into detergent compositions for laundry cleaning, especially for use in domestic washing machines and/or for hand-washing use. These compositions can be in any conventional form, namely, in the form of a liquid, powder, granules, agglomerate, paste, tablet, pouches, bar, gel, types delivered in dual-compartment containers, spray or foam detergents and other homogeneous or multiphase consumer cleaning product forms. In addition to detergent compositions, the compounds of the present invention may be also suitable for use or incorporation into: personal cleaning compositions (i.e. shampoo, body wash, lotions), vehicles and/or carriers for the delivery of pharmaceuticals, industrial cleaners (i.e. floor cleaners), polymerization purposes, solubilization and/or dispersion of agricultural chemicals, solubilization and/or dispersion of fuels (i.e. diesel fuel/water and/or alcohol mixtures; jet fuel/water and/or alcohol mixtures; heavy oil/water mixtures; ORIMULSION™) and mixtures thereof.

The detergent compositions of the present invention can be used or applied by hand and/or can be applied in unitary or freely alterable dosage, or by automatic dispensing means, or are useful in appliances such as washing-machines or dishwashers or can be used in institutional cleaning contexts, including for example, for personal cleansing in public facilities, for bottle washing, for surgical instrument cleaning or for cleaning electronic components. They can be used in aqueous or non-aqueous cleaning systems. They can have a wide range of pH, for example from about 2 to about 12 or higher, though alkaline detergent compositions having a pH of from about 8 to about 11, and they can have a wide range of alkalinity reserve which can include very high alkalinity reserves as in uses such as drain unblocking in which tens of grams of NaOH equivalent can be present per 100 grams of formulation, ranging through the 1-10 grams of NaOH equivalent and the mild or low-alkalinity ranges of liquid hand cleaners, down to the acid side such as in acidic hard-surface cleaners. Both high-foaming and low-foaming detergent types are encompassed, as well as types for use in all known aqueous and non-aqueous consumer product-cleaning processes.

Detergent Adjunct Materials and Methods of use

In general, a detergent adjunct is any material required to transform a detergent composition containing only the minimum essential ingredients (herein the alkyl phenyl alkanols and alkyl phenyl alkanol derivatives) into a detergent composition useful for laundry, consumer, commercial and/or industrial cleaning purposes. In certain embodiments, detergent adjuncts are easily recognizable to those of skill in the art as being absolutely characteristic of detergent products, especially of detergent products intended for direct use by a consumer in a domestic environment.

The precise nature of these additional components, and levels of incorporation thereof, will depend on the physical form of the detergent composition and the nature of the cleaning operation for which it is to be used.

The detergent adjunct ingredients if used with bleach should have good stability therewith. Certain embodiments of detergent compositions herein should be boron-free and/or phosphate-free as required by legislation. Levels of detergent adjuncts are from about 0.00001% to about 99.9%, by weight of the detergent compositions. Use levels of the overall detergent compositions can vary widely depending on the intended application, ranging for example from a few ppm in solution to so-called “direct application” of the neat detergent composition to the surface to be cleaned.

Common adjuncts include builders, surfactants, enzymes, polymers, bleaches, bleach activators, catalytic materials and the like excluding any materials already defined hereinabove as part of the essential component of the inventive compositions. Other adjuncts herein can include suds boosters, suds suppressors (antifoams) and the like, diverse active ingredients or specialized materials such as dispersant polymers (e.g., from BASF Corp. or Rohm & Haas), color speckles, silvercare, anti-tarnish and/or anti-corrosion agents, dyes, fillers, germicides, alkalinity sources, hydrotropes, anti-oxidants, enzyme stabilizing agents, pro-perfumes, perfumes, solubilizing agents, carriers, processing aids, pigments, and, for liquid formulations, solvents.

Quite typically, detergent compositions herein such as laundry detergents, laundry detergent additives, hard surface cleaners, synthetic and soap-based laundry bars, fabric softeners and fabric treatment liquids, solids and treatment articles of all kinds will require several adjuncts, though certain simply formulated products, such as bleach additives, may require only, for example, an oxygen bleaching agent and a surfactant as described herein. A comprehensive list of suitable laundry or cleaning adjunct materials and methods can be found in WO 99/05242.

Method of use

The present invention includes a method for cleaning a situs inter alia a surface or fabric. Such method includes the steps of contacting an embodiment of Applicants' detergent composition, in neat form or diluted in a wash liquor, with at least a portion of a surface or fabric then rinsing such surface or fabric. Preferably the surface or fabric is subjected to a washing step prior to the aforementioned rinsing step. For purposes of the present invention, washing includes but is not limited to, scrubbing, and mechanical agitation. As will be appreciated by one skilled in the art, the detergent compositions of the present invention are ideally suited for use in laundry applications. Accordingly, the present invention includes a method for laundering a fabric. The method comprises the steps of contacting a fabric to be laundered with a said cleaning laundry solution comprising at least one embodiment of a detergent composition, cleaning additive or mixture thereof comprising the alkyl phenyl alkanols and derivatives thereof of the present invention. The fabric may comprise most any fabric capable of being laundered in normal consumer use conditions. The solution preferably has a pH of from about 8 to about 10. The compositions are preferably employed at concentrations of from about 500 ppm to about 10,000 ppm in solution. The water temperatures preferably range from about 5° C. to about 60° C. The water to fabric ratio is preferably from about 1:1 to about 20:1.

### DETERGENT COMPOSITION EXAMPLES

The following abbreviations are used for detergent adjunct materials:

| | |
|---|---|
| Amylase | Amylolytic enzyme of activity 60 KNU/g sold by |
| | NOVO Industries A/S under the tradename |
| | TERMAMYL ® 60T. Alternatively, the |
| | amylase is selected from: FUNGAMYL ®; |
| | DURAMYL ®; BAN ®; and α-amylase |
| | enzymes described in WO 95/26397 and in |
| | WO 96/23873. |
| APA | C₈-C₁₀ amido propyl dimethyl amine |
| Borax | Na tetraborate decahydrate |
| Brightener 1 | Disodium 4,4′-bis(2-sulphostyryl)biphenyl |
| Brightener 2 | Disodium 4,4′-bis(4-anilino-6-morpholino-1.3.5- |
| | triazin-2-yl)amino) stilbene-2:2′-disulfonate |
| Carbonate | Na₂CO₃ anhydrous, 200 μm-900 μm |
| Cellulase | Cellulolytic enzyme, 1000 CEVU/g, NOVO, |
| | Carezyme ® |
| Citrate | Trisodium citrate dihydrate, 86.4%, 425 μm-850 μm |
| Citric Acid | Citric Acid, Anhydrous |
| CxyAS | Alkyl sulfate, Na salt or other salt if specified having |
| | an average total carbon range of alkyl moiety from |
| | 10 + x to 10 + y |
| CxyEz | Commercial linear or branched alcohol ethoxylate (not |
| | having mid-chain methyl branching) and having an |
| | average total carbon range of alkyl moiety from 10 + x |
| | to 10 + y average z moles of ethylene oxide |
| CxyEzS | Alkyl ethoxylate sulfate, Na salt (or other salt if |
| | specified) having an average total carbon range of |
| | alkyl moiety from 10 + x to 10 + y and an average |
| | of z moles of ethylene oxide |
| Dimethicone | 40 (gum)/60 (fluid) wt. Blend of SE-76 dimethicone |
| | gum (G.E Silicones Div.)/dimethicone fluid of |
| | viscosity 350 cS. |
| DTPA | Diethylene triamine pentaacetic acid |
| EtOH | Ethanol |
| Fatty Acid (TPK) | Topped palm kernel fatty acid |
| Formate | Formate (Sodium) |
| Hydrotrope | selected from sodium, potassium, Magnesium, |
| | Calcium, ammonium or water-soluble substituted |
| | ammonium salts of toluene sulfonic acid, naphthalene |
| | sulfonic acid, cumene sulfonic acid, xylene sulfonic |
| | acid. |
| LAS | Linear Alkylbenzene Sulfonate (e.g., C_{11.8}, Na²⁺ or |
| | K⁺ salt) |
| Lipase | Lipolytic enzyme, 100 kLU/g, NOVO, LIPOLASE ®. |
| | Alternatively, the lipase is selected from: |
| | AMANO-P ®; M1 LIPASE ®; LIPOMAX ®; |
| | D96L—lipolytic enzyme variant of the native lipase |
| | derived from Humicola lanuginosa as described in |
| | WO 96/16153; and the Humicola lanuginosa strain |
| | DSM 4106. |
| LMFAA | C₁₂₋₁₄ alkyl N-methyl glucamide |
| Maxus | Mid-chain branched or modified primary alkyl |
| | ethoxylate sulfate, Na salt (average total carbons = x; |
| | average EO = y) |
| MBAyS | Mid-chain branched primary alkyl sulfate, Na salt |
| | (average total carbons = y) |
| MEA | Monoethanolamine |
| Cxy MES | Alkyl methyl ester sulfonate, Na salt having an |
| | average total carbon range of alkyl moiety from 10 + x |
| | to 10 + y |
| MnCAT | Macrocyclic Manganese Bleach Catalyst |
| | as in EP 544,440 A or, preferably, use |
| | [Mn(Bcyclam)Cl₂] wherein Bcyclam = 5,12-dimethyl- |
| | 1,5,8,12-tetraaza-bicyclo[6.6.2]hexadecane or a |
| | comparable bridged tetra-aza macrocycle |
| NaOH | Sodium hydroxide |
| Cxy NaPS | Paraffin sulfonate, Na salt having an average total |
| | carbon range of alkyl moiety from 10 + x to 10 + y |
| NaTS | Sodium toluene sulfonate |
| NOBS | Nonanoyloxybenzene sulfonate, sodium salt |
| LOBS | C12 oxybenzenesulfonate, sodium salt |
| PAA | Polyacrylic Acid (weight average mw = 4500 daltons) |
| PAE | Ethoxylated tetraethylene pentamine |
| PAEC | Methyl quaternized ethoxylated dihexylene triamine |
| PB1 | Anhydrous sodium perborate bleach of nominal |
| | formula NaBO₂.H₂O₂ |
| PEG | Polyethylene glycol (weight average mw = 4600 |
| | daltons) |
| Percarbonate | Sodium Percarbonate of nominal formula |
| | 2Na₂CO₃.3H₂O₂ |
| PG | Propanediol |
| PIE | Ethoxylated polyethyleneimine, water-soluble |
| Protease | Proteolytic enzyme, 4KNPU/g, NOVO, |
| | SAVINASE ®. Alternatively, the protease is selected |
| | from: MAXATASE ®; MAXACAL ®; MAXAPEM |
| | 15 ®; subtilisin BPN and BPN′; Protease B; |
| | Protease A; Protease D; PRIMASE ®; |
| | DURAZYM ®; OPTICLEAN ®; and |
| | OPTIMASE ®; and ALCALASE ®. |
| QAS | R₂.N⁺(CH₃)ₓ((C₂H₄O)yH)z with R₂ = C₈-C₁₈ |
| | x + z = 3, x = 0 to 3, z = 0 to 3, y = 1 to 15. |
| Cxy SAS | Secondary alkyl sulfate, Na salt having an average |
| | total carbon range of alkyl moiety from 10 + x |
| | to 10 + y |
| Silicate | Sodium Silicate, amorphous (SiO₂:Na₂O; 2.0 ratio) |
| Silicone antifoam | Polydimethylsiloxane foam controller + siloxane- |
| | oxyalkylene copolymer as dispersing agent; ratio |
| | of foam controller:dispersing agent = 10:1 to 100:1; or, |
| | combination of fumed silica and high viscosity |
| | polydimethylsiloxane (optionally chemically modified) |
| Solvent | nonaqueous solvent e.g., hexylene glycol, see also |
| | propylene glycol |
| SRP 1 | Sulfobenzoyl end capped esters with oxyethylene |
| | oxy and terephthaloyl backbone |
| SRP 2 | Sulfonated ethoxylated terephthalate polymer |
| STPP | Sodium tripolyphosphate, anhydrous |
| Sulfate | Sodium sulfate, anhydrous |
| TAED | Tetraacetylethylenediamine |
| Zeolite A | Hydrated Sodium Aluminosilicate, Na₁₂(A10₂SiO₂)₁₂. |
| | 27H₂O; 0.1-10 μm |
| Zeolite MAP | Zeolite (Maximum Aluminum P) detergent grade |
| | available from Crosfield |

Typical ingredients often referred to as “minors” can include perfumes, dyes, pH trims etc. The following examples are illustrative of the present invention, but are not intended to limit or otherwise define its scope. All parts, percentages and ratios used are expressed as percent weight of the detergent composition unless otherwise noted.

### Example 10

The following laundry detergent compositions A to F are prepared in accordance with the invention:

| | A | B | C | D | E | F |
|---|---|---|---|---|---|---|
| Sodium Dodecylphenyl | 22 | 16.5 | 11 | 1-5.5 | 10-25 | 5-35 |
| alkanol sulfate | | | | | | |
| (Q = —CH₂—) | | | | | | |
| Any Combination of: | 0 | 1-5.5 | 11 | 16.5 | 0-5 | 0-10 |
| C₄₅AS | | | | | | |
| C₄₅E₁S or C₂₃E₃S | | | | | | |
| LAS | | | | | | |
| C₂₆ SAS | | | | | | |
| C₄₇ NaPS | | | | | | |
| C₄₈ MES | | | | | | |
| MBA_{16.5}S | | | | | | |
| MBA_{15.5}E₂S | | | | | | |
| QAS | 0-2 | 0-2 | 0-2 | 0-2 | 0-4 | 0 |
| C₂₃E_{6.5} or C₄₅E₇ | 1.5 | 1.5 | 1.5 | 1.5 | 0-4 | 0-4 |
| Zeolite A | 27.8 | 0 | 27.8 | 27.8 | 20-30 | 0 |
| Zeolite MAP | 0 | 27.8 | 0 | 0 | 0 | 0 |
| STPP | 0 | 0 | 0 | 0 | 0 | 5-65 |
| PAA | 2.3 | 2.3 | 2.3 | 2.3 | 0-5 | 0-5 |
| Carbonate | 27.3 | 27.3 | 27.3 | 27.3 | 20-30 | 0-30 |
| Silicate | 0.6 | 0.6 | 0.6 | 0.6 | 0-2 | 0-6 |
| PB1 | 1.0 | 1.0 | 0-10 | 0-10 | 0-10 | 0-20 |
| NOBS | 0-1 | 0-1 | 0-1 | 0.1 | 0.5-3 | 0-5 |
| LOBS | 0 | 0 | 0-3 | 0 | 0 | 0 |
| TAED | 0 | 0 | 0 | 2 | 0 | 0-5 |
| MnCAT | 0 | 0 | 0 | 0 | 2 ppm | 0-1 |
| Protease | 0-0.5 | 0-0.5 | 0-0.5 | 0-0.5 | 0-0.5 | 0-1 |
| Cellulase | 0-0.3 | 0-0.3 | 0-0.3 | 0-0.3 | 0-0.5 | 0-1 |
| Amylase | 0-0.5 | 0-0.5 | 0-0.5 | 0-0.5 | 0-1 | 0-1 |
| SRP 1 or SRP 2 | 0.4 | 0.4 | 0.4 | 0.4 | 0-1 | 0-5 |
| Brightener 1 or 2 | 0.2 | 0.2 | 0.2 | 0.2 | 0-0.3 | 0-5 |
| PEG | 1.6 | 1.6 | 1.6 | 1.6 | 0-2 | 0-3 |
| Silicone Antifoam | 0.42 | 0.42 | 0.42 | 0.42 | 0-0.5 | 0-1 |
| Sulfate, Water, Minors | to | to | to | to | to | to |
| | 100% | 100% | 100% | 100% | 100% | 100% |
| Density (g/L) | 400- | 600- | 600- | 600- | 600- | 450- |
| | 700 | 700 | 700 | 700 | 700 | 750 |

### Example 11

The following laundry detergent compositions G to J suitable for hand-washing soiled fabrics are prepared in accord with the invention:

| | G | H | I | J |
|---|---|---|---|---|
| Sodium Dodecylphenyl | 18 | 22 | 18 | 22 |
| alkanol sulfate | | | | |
| (Q = —CH₂—) | | | | |
| STPP | 20 | 40 | 22 | 28 |
| Carbonate | 15 | 8 | 20 | 15 |
| Silicates | 15 | 10 | 15 | 10 |
| Protease | 0 | 0 | 0.3 | 0.3 |
| Perborate (PB1) | 0 | 0 | 0 | 10 |
| Sodium Chloride | 25 | 15 | 20 | 10 |
| Brightener (1 or 2) | 0-0.3 | 0.2 | 0.2 | 0.2 |

| | |
|---|---|
| water & Minors | ---Balance--- |

### Example 12

Cleaning Product Compositions

The following liquid laundry detergent compositions K to O are prepared in accord with the invention. Abbreviations are as used in the preceding Examples.

| | K | L | M | N | O |
|---|---|---|---|---|---|
| Sodium Dodecylphenyl alkanol sulfate | 1-7 | 7-12 | 12-17 | 17-22 | 1-35 |
| (formula (I) wherein Q = —CH₂—) | | | | | |
| Any combination of: | 15-21 | 10-15 | 5-10 | 0-5 | 0-25 |
| C₂₅E_{1.8-2.5}S | | | | | |
| MBA_{15.5}E_{1.8}S | | | | | |
| MBA_{15.5}S | | | | | |
| C₂₅AS (linear to high 2-alkyl) C₄₇ NaPS | | | | | |
| C₂₆ SAS | | | | | |
| LAS | | | | | |
| C₂₆ MES | | | | | |
| LMFAA | 0-3.5 | 0-3.5 | 0-3.5 | 0-3.5 | 0-8 |
| C₂₃E₉ or C₂₃E_{6.5} | 0-2 | 0-2 | 0-2 | 0-2 | 0-8 |
| APA | 0-0.5 | 0-0.5 | 0-0.5 | 0-0.5 | 0-2 |
| Citric Acid | 5 | 5 | 5 | 5 | 0-8 |
| Fatty Acid (TPK or C_{12/14}) | 2 | 2 | 2 | 2 | 0-14 |
| EtOH | 4 | 4 | 4 | 4 | 0-8 |
| PG | 6 | 6 | 6 | 6 | 0-10 |
| MBA | 1 | 1 | 1 | 1 | 0-3 |
| NaOH | 3 | 3 | 3 | 3 | 0-7 |
| Hydrotrope or NaTS | 2.3 | 2.3 | 2.3 | 2.3 | 0-4 |
| Formate | 0.1 | 0.1 | 0.1 | 0.1 | 0-1 |
| Borax | 2.5 | 2.5 | 2.5 | 2.5 | 0-5 |
| Protease | 0.9 | 0.9 | 0.9 | 0.9 | 0-1.3 |
| Lipase | 0.06 | 0.06 | 0.06 | 0.06 | 0-0.3 |
| Amylase | 0.15 | 0.15 | 0.15 | 0.15 | 0-0.4 |
| Cellulase | 0.05 | 0.05 | 0.05 | 0.05 | 0-0.2 |
| PAE | 0-0.6 | 0-0.6 | 0-0.6 | 0-0.6 | 0-2.5 |
| PIE | 1.2 | 1.2 | 1.2 | 1.2 | 0-2.5 |
| PAEC | 0-0.4 | 0-0.4 | 0-0.4 | 0-0.4 | 0-2 |
| SRP 2 | 0.2 | 0.2 | 0.2 | 0.2 | 0-0.5 |
| Brightener 1 or 2 | 0.15 | 0.15 | 0.15 | 0.15 | 0-0.5 |
| Silicone antifoam | 0.12 | 0.12 | 0.12 | 0.12 | 0-0.3 |
| Fumed Silica | 0.0015 | 0.0015 | 0.0015 | 0.0015 | 0-0.003 |
| Perfume | 0.3 | 0.3 | 0.3 | 0.3 | 0-0.6 |
| Dye | 0.0013 | 0.0013 | 0.0013 | 0.0013 | 0-0.003 |
| water/minors | Balance | Balance | Balance | Balance | Balance |
| Product pH (10% in DI water) | 7.7 | 7.7 | 7.7 | 7.7 | 6-9.5 |

### Example 13

Non-limiting examples P-Q of a bleach-containing nonaqueous liquid laundry detergent composition are prepared as follows:

| | P | Q |
|---|---|---|
| Component | Wt. % | Range (% wt.) |
| Liquid Phase | | |
| Sodium 2-Dodecylphenyl | 15 | 1-35 |
| ethyl-1-sulfate (formula (I) | | |
| wherein Q = —CH₂CH₂—) | | |
| LAS | 12 | 0-35 |
| C₂₄E₅ | 14 | 10-20 |
| Solvent or Hexylene glycol | 27 | 20-30 |
| Perfume | 0.4 | 0-1 |
| Solid Phase | | |
| Protease | 0.4 | 0-1 |
| Citrate | 4 | 3-6 |
| PB1 | 3.5 | 2-7 |
| NOBS | 8 | 2-12 |
| Carbonate | 14 | 5-20 |
| DTPA | 1 | 0-1.5 |
| Brightener 1 | 0.4 | 0-0.6 |
| Silicon antifoam | 0.1 | 0-0.3 |
| Minors | Balance | Balance |

The resulting anhydrous heavy duty liquid laundry detergent provides excellent stain and soil removal performance when used in normal fabric laundering operations.

### Example 14

The following examples R-V further illustrate the invention herein with respect to shampoo formulations.

| Component | R | S | T | U | V |
|---|---|---|---|---|---|
| Ammonium C₂₄E₂S | 5 | 3 | 2 | 10 | 8 |
| Ammonium C₂₄AS | 5 | 5 | 4 | 5 | 8 |
| Sodium Dodecylphenyl | 0.6 | 1 | 4 | 5 | 7 |
| alkanol sulfate (Q = —CH₂—) | | | | | |
| Cocamide MEA | 0 | 0.68 | 0.68 | 0.8 | 0 |
| PEG 14,000 daltons weight | 0.1 | 0.35 | 0.5 | 0.1 | 0 |
| average mol. wt. | | | | | |
| Cocoamidopropylbetaine | 2.5 | 2.5 | 0 | 0 | 1.5 |
| Cetyl alcohol | 0.42 | 0.42 | 0.42 | 0.5 | 0.5 |
| Stearyl alcohol | 0.18 | 0.18 | 0.18 | 0.2 | 0.18 |
| Ethylene glycol distearate | 1.5 | 1.5 | 1.5 | 1.5 | 1.5 |
| Dimethicone | 1.75 | 1.75 | 1.75 | 1.75 | 2.0 |
| Perfume | 0.45 | 0.45 | 0.45 | 0.45 | 0.45 |
| Water and minors | balance | balance | balance | balance | balance |

What is claimed is:

1. A compound having the formula: 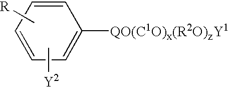
wherein R is C₅-C₃₀ linear or branched alkyl, and mixtures thereof; R¹ and R² are independently selected from linear or branched C₁-C₆ alkylene; Q is a hydrocarbon moiety containing between one and six carbon atoms; Y¹ and Y² are hydrogen, SO₃M, and mixtures thereof; the index x is from 0 to 50; the index z is from 0 to 20; M is an alkali metal, alkaline earth metal, organic counterion, ammonium, substituted ammonium or mixtures thereof.

2. The compound according to claim 1 wherein R¹ and R² are independently selected from the group comprising ethylene, propylene, and mixtures thereof; Y¹ and Y² are hydrogen; the index x is from 0 to 20; the index z is from 0 to 3.

3. The compound according to claim 1, wherein Q is —CH₂—.

4. The compound according to claim 1, wherein Q is —CH₂—CH₂—.

5. The compound according to claim 1, wherein R comprises a degree of substitution selected from the group consisting of: zero methyl branches, one methyl branch, two methyl branches and mixtures thereof.

6. The compound according to claim 1, wherein the aromatic ring of formula (I) is attached to R on a terminal, alpha or beta carbon atom of R.

7. The compound according to claim 1, wherein Q and R are substantially free from quaternary type branching.

8. The compound according to claim 1 wherein Q and R are in the para position, relative to each other.

9. The compound according to claim 1 wherein Q and R are in the ortho position, relative to each other.

10. The compound according to claim 1 wherein Q and R are in the meta position, relative to each other.

11. The compound according to claim 1 wherein Y¹ is hydrogen, SO₃M, and mixtures thereof; Y² is hydrogen, SO₃M and mixtures thereof, so long as at least one of either Y¹ or Y² is SO₃M; the index x is from 0 to 20; the index z is from 0 to 3; further wherein M is selected from the group consisting of: alkali metals, alkaline earth metals, organic counterions, ammonium, substituted ammonium and mixtures thereof.

12. The compound of claim 11, wherein M is selected from the group consisting of: sodium, potassium, magnesium, calcium, monoethanolamine (MEA), triaethanolamine (TEA) and mixtures thereof.

13. A surfactant system comprising the compound of claim 1; the compound of claim 2; the compound of claim 11; or any combination thereof; and one or more surfactants selected from the group consisting of: alkylbenzensulfonates; linear alkylbenzenesulfonates; modified linear alkylbenzenesulfonates; linear, branched and mid-chain branched alkanolsulfates; linear, branched and mid-chain branched alkanolethoxylates; linear, branched and mid-chain branched alkanolethoxyatesulfates; alkylpolyglucanols; alphaolefinsulfonates, methylestersulfonates; and mixtures thereof.

14. A detergent composition comprising the compound of claim 1.

15. A method for treating an article in need of treatment comprising the step of contacting the article with a detergent composition according to claim 14.
